(19) United States
(12) Patent Application Publication
(10) Pub. No.: US 2025/0266622 A1
(43) Pub. Date: Aug. 21, 2025

(54) ANTENNA, DECOUPLING STRUCTURE, AND COMMUNICATION DEVICE

(71) Applicant: HUAWEI TECHNOLOGIES CO., LTD., Shenzhen (CN)

(72) Inventors: Bo CHENG, Shanghai (CN); Meiqing QI, Shanghai (CN); Xiao ZHOU, Shanghai (CN)

(21) Appl. No.: 19/203,602

(22) Filed: May 9, 2025

Related U.S. Application Data
(63) Continuation of application No. PCT/CN2023/118707, filed on Sep. 14, 2023.

(30) Foreign Application Priority Data
Nov. 10, 2022 (CN) 202211405520.1

(51) Int. Cl. H01Q 19/00; H01Q 1/52; H01Q 25/00

(52) U.S. Cl. CPC H01Q 19/005; H01Q 1/523; H01Q 25/001

(57) ABSTRACT

An example antenna includes a ground plate, a conductor sheet, a first metal structure, and a second metal structure. In a vertical direction of the antenna, the first metal structure and the second metal structure are located above the conductor sheet, the conductor sheet is located above the ground plate, a distance between the first metal structure and the ground plate ranges from 0.01 to 0.2 times a wavelength of the antenna, and a distance between the second metal structure and the ground plate is less than or equal to the distance between the first metal structure and the ground plate. In a horizontal direction of the antenna, the first metal structure and the second metal structure are perpendicular to each other. The first metal structure and the second metal structure with low heights are loaded above an antenna element as a parasitic decoupling structure.

### CROSS-REFERENCE TO RELATED APPLICATIONS

This application is a continuation of International Application No. PCT/CN2023/118707, filed on Sep. 14, 2023, which claims priority to Chinese Patent Application No. 202211405520.1, filed on Nov. 10, 2022. The disclosures of the aforementioned applications are hereby incorporated by reference in their entireties.

### TECHNICAL FIELD

Embodiments of this application relate to the communication field, and in particular, to an antenna, a decoupling structure, and a communication device.

### BACKGROUND

With development of the 5th generation mobile communication technology (5G), a massive multiple-in multiple-out (MM) technology is becoming a key technology of mobile communication.

In an MM system, a base station antenna includes a large quantity of antenna elements. Due to limited installation space of the antenna, a spacing between the antenna elements is limited to some extent. As a result, there is a high degree of mutual coupling between adjacent elements in the antenna. If there is a high degree of mutual coupling between the antenna elements, performance of an array antenna is severely deteriorated, for example, a gain of large-angle scanning and active matching performance of large-angle scanning are reduced. Moreover, spectrum utilization of the array antenna is reduced. Currently, an array antenna decoupling surface (ADS) is widely used to resolve the foregoing disadvantage. The ADS is a decoupling structure applicable to a dual-polarization array antenna.

However, a conventional ADS decoupling structure has a high profile height, which increases a size and a weight of the antenna to some extent.

### SUMMARY

Embodiments of this application provide an antenna, to implement antenna decoupling. Embodiments of this application further provide a corresponding decoupling structure and communication device.

A first aspect of this application provides an antenna. The antenna includes a ground plate, a conductor sheet, a first metal structure, and a second metal structure. In a vertical direction of the antenna, the first metal structure and the second metal structure are located above the conductor sheet, the conductor sheet is located above the ground plate, a distance between the first metal structure and the ground plate is 0.01 to 0.2 times a wavelength of the antenna, and a distance between the second metal structure and the ground plate is less than or equal to the distance between the first metal structure and the ground plate. In a horizontal direction of the antenna, the first metal structure and the second metal structure are perpendicular to each other.

In this application, to better describe the antenna, a three-dimensional coordinate system is established for the antenna. The vertical direction of the antenna is a Z-axis direction, and horizontal directions of the antenna are an X-axis direction and a Y-axis direction.

The antenna in this application is a dual-polarization antenna, the conductor sheet may be understood as an array element of the antenna, and the array element is a ±45° dual-polarization conductor sheet.

In this application, the first metal structure is parallel to the X-axis direction, the second metal structure is parallel to the Y-axis direction, and the first metal structure and the second metal structure are specifically conductive patches, may be distributed in a same plane or different planes, and are not connected to each other. Based on an electromagnetic wave diffraction effect and coupling effect, the first metal structure and the second metal structure are loaded above the antenna element as a parasitic decoupling structure. In the vertical direction of the antenna, the distance between the first metal structure and the ground plate may be 0.01 to 0.2 times the wavelength of the antenna, for example, 0.156 times the wavelength of the antenna. The distance between the second metal structure and the ground plate is less than or equal to the distance between the first metal structure and the ground plate. In this way, in the foregoing distance limitation, an additional coupling path can still be introduced, to offset original coupling energy, so that antenna decoupling is implemented. It can be learned that in the vertical direction of the antenna, a height of the antenna may be low, to reduce a size of the antenna. This avoids a problem of increased costs, size, and weight.

According to the first aspect, the first metal structure and the second metal structure with low heights are loaded above the antenna element as the parasitic decoupling structure, so that the additional coupling path can be introduced, to offset the original coupling energy. This implements antenna decoupling without significantly increasing the size and the weight of the antenna.

In a possible implementation of the first aspect, the antenna further includes a fastening structure, and in a vertical direction of the antenna, the fastening structure is disposed above the conductor sheet, and the first metal structure is disposed on a surface of the fastening structure.

In this possible implementation, the first metal structure is fastened through the fastening structure. This improves implementability of the solution.

In a possible implementation of the first aspect, the antenna further includes a third metal structure, and in the vertical direction of the antenna, the third metal structure is disposed on the surface and/or a bottom surface of the fastening structure; and in the horizontal direction of the antenna, the third metal structure is located on two sides of the first metal structure and the second metal structure, and the third metal structure is parallel to the first metal structure.

In this possible implementation, the third metal structure is loaded, so that self-isolation of the antenna can be improved, and isolation between adjacent elements can be improved.

In a possible implementation of the first aspect, the antenna further includes a fourth metal structure, and the fourth metal structure is parallel to the vertical direction of the antenna; at least one end of the fourth metal structure is connected to the third metal structure; and the fourth metal structure is configured to connect the surface of the fastening structure to the bottom surface of the fastening structure.

In this possible implementation, the fourth metal structure is loaded, so that a cross-polarization ratio of the antenna can be improved, to improve a polarization effect of the antenna.

In a possible implementation of the first aspect, the antenna further includes a parasitic patch, and in the vertical direction of the antenna, the parasitic patch is located above the conductor sheet and below the first metal structure; and the parasitic patch is disposed inside the fastening structure.

In this possible implementation, the parasitic patch can extend bandwidth of the antenna.

In a possible implementation of the first aspect, in the vertical direction of the antenna, a height of the second metal structure is between a height of the first metal structure and a height of the parasitic patch.

In this possible implementation, the second metal structure may not be disposed on the surface of the fastening structure, but may be disposed inside the fastening structure. This improves implementability of the solution.

In a possible implementation of the first aspect, in the horizontal direction of the antenna, the first metal structure and the second metal structure are located on two sides of the conductor sheet.

In this possible implementation, the first metal structure and the second metal structure may not be located right above the conductor sheet, but may be located on the two sides of the conductor sheet. This improves implementability of the solution.

In a possible implementation of the first aspect, the antenna further includes a substrate, and in the vertical direction of the antenna, the conductor sheet is disposed on a surface of the substrate, and the substrate is disposed on a surface of the ground plate.

In this possible implementation, the substrate may be further disposed in the antenna, the conductor sheet may be disposed on the surface of the substrate, and the substrate may be disposed on the surface of the ground plate. This improves implementability of the solution.

In a possible implementation of the first aspect, in the horizontal direction of the antenna, lengths of the first metal structure and the second metal structure are 0.1 to 1 times the wavelength of the antenna.

In this possible implementation, the lengths of the first metal structure and the second metal structure are 0.1 to 1 times the wavelength of the antenna. This avoids the problem of increased costs, size, and weight caused after the decoupling structure is added.

In a possible implementation of the first aspect, the first metal structure and the second metal structure are in one or more of a rectangle shape, a zigzag shape, a curved shape, or a ring shape.

In this possible implementation, the first metal structure and the second metal structure may be in a plurality of shapes. This improves implementability of the solution.

In a possible implementation of the first aspect, a structure of the fourth metal structure is one or more of a metal sheet, a metal column, and a metal through via.

In this possible implementation, the structure of the fourth metal structure may be a plurality of structures. This improves implementability of the solution.

In a possible implementation of the first aspect, the antenna is a dual-polarization antenna.

In this possible implementation, the antenna is the dual-polarization antenna. This improves implementability of the solution.

A second aspect of this application provides a decoupling structure. The decoupling structure includes a first metal structure, a second metal structure, a third metal structure, a fourth metal structure, and a fastening structure. In a vertical direction of the decoupling structure, the first metal structure is disposed on a surface of the fastening structure, and the third metal structure is disposed on the surface and/or a bottom surface of the fastening structure. In a horizontal direction of the decoupling structure, the first metal structure and the second metal structure are perpendicular to each other, the third metal structure is located on two sides of the first metal structure and the second metal structure, the third metal structure is parallel to the first metal structure, the fourth metal structure is parallel to the vertical direction of the decoupling structure, at least one end of the fourth metal structure is connected to the third metal structure, and the fourth metal structure is configured to connect the surface of the fastening structure to the bottom surface of the fastening structure. In a possible implementation of the second aspect, the decoupling structure further includes a parasitic patch, and in the vertical direction of the decoupling structure, the parasitic patch is located below the first metal structure; and the parasitic patch is disposed inside the fastening structure.

In a possible implementation of the second aspect, in the vertical direction of the decoupling structure, a height of the second metal structure is between a height of the first metal structure and a height of the parasitic patch.

In a possible implementation of the second aspect, the first metal structure and the second metal structure are in one or more of a rectangle shape, a zigzag shape, a curved shape, or a ring shape.

In a possible implementation of the second aspect, a structure of the fourth metal structure is one or more of a metal sheet, a metal column, and a metal through via.

A third aspect of this application provides a communication device. The communication device includes the antenna according to any one of the first aspect or the possible implementations of the first aspect, and a radio frequency component coupled to the antenna.

In this embodiment of this application, the first metal structure and the second metal structure with low heights are loaded above the antenna element as a parasitic decoupling structure, so that an additional coupling path can be introduced, to offset original coupling energy. This implements antenna decoupling without significantly increasing a size and a weight of the antenna.

### BRIEF DESCRIPTION OF DRAWINGS

FIG. 1 is a diagram of an application scenario of a base station;

FIG. 2 is a diagram of an embodiment of an antenna according to an embodiment of this application;

FIG. 3 is a diagram of another embodiment of an antenna according to an embodiment of this application;

FIG. 4 is a diagram of a first metal structure and a second metal structure according to an embodiment of this application;

FIG. 5 to FIG. 7 are diagrams of effect comparison after an antenna is loaded with a decoupling structure according to an embodiment of this application;

FIG. 8 is a diagram of an embodiment of a decoupling structure according to an embodiment of this application; and

FIG. 9 is a diagram of an embodiment of a communication device according to an embodiment of this application.

### DESCRIPTION OF EMBODIMENTS

The following describes embodiments of this application with reference to the accompanying drawings. It is clear that the described embodiments are merely some rather than all of embodiments of this application. A person of ordinary skill in the art may learn that, with development of technologies and emergence of a new scenario, technical solutions provided in embodiments of this application are also applicable to a similar technical problem.

In this specification, claims, and accompanying drawings of this application, the terms “first”, “second”, and so on are intended to distinguish between similar objects but do not necessarily indicate a specific order or sequence. It should be understood that data termed in such a way are interchangeable in proper circumstances so that embodiments described herein can be implemented in other orders than the order illustrated or described herein. In addition, the terms “include” and “have” and any other variants are intended to cover the non-exclusive inclusion. For example, a process, method, system, product, or device that includes a list of steps or units is not necessarily limited to those expressly listed steps or units, but may include other steps or units not expressly listed or inherent to such a process, method, product, or device.

The special term “example” herein means “used as an example, embodiment, or illustration”. Any embodiment described as “example” is not necessarily explained as being superior or better than other embodiments.

In addition, to better describe this application, numerous specific details are given in the following specific implementations. A person skilled in the art should understand that this application can also be implemented without some specific details. In some instances, methods, means, elements, and circuits that are well-known to a person skilled in the art are not described in detail, so that a subject matter of this application is highlighted.

Embodiments of this application provide an antenna, to implement antenna decoupling. Embodiments of this application further provide a corresponding decoupling structure and communication device. Details are separately described in the following.

The following uses an example to describe an application scenario in embodiments of this application.

In the 5th generation mobile communication technology (5G), a massive multiple-in multiple-out (MM) technology is a widely used antenna technology for wireless communication. In this technology, a massive quantity of antennas are used for both a source (transmitter) and a destination (receiver). The antenna at each end of a communication loop is combined to achieve a minimum bit error rate and an optimal data transmission speed.

A dual-polarization antenna is a new antenna technology, combines two antennas with orthogonal polarization directions +45°/−45° (or) 0°/90°, and simultaneously operates in a transceiver duplex mode. Therefore, a most prominent advantage of the dual-polarization antenna is that a quantity of antennas of a single directional base station is reduced.

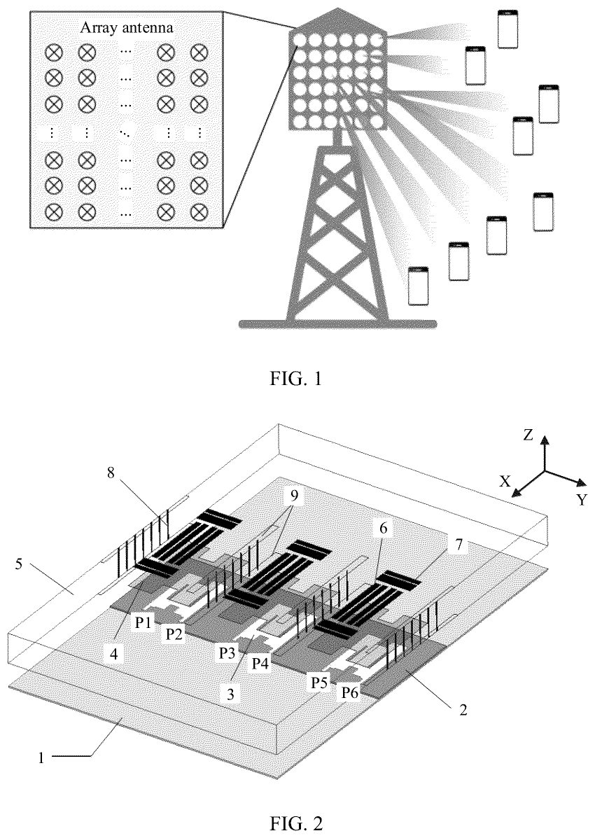

As shown in FIG. 1, in an MM system of a base station, a base station antenna may transmit a signal to a plurality of user equipments. The base station antenna, namely, a dual-polarization array antenna, includes a large quantity of dual-polarization antenna elements. Due to limited installation space of the antenna, a spacing between the antenna elements is limited to some extent. As a result, there is high mutual coupling between adjacent elements in the antenna. In the array antenna, high mutual coupling between the antenna elements severely deteriorates performance of the array antenna, for example, a gain of large-angle scanning, active matching of large-angle scanning, and diversity performance of the MIMO system. In addition, high mutual coupling between the elements also reduces spectrum utilization of the array antenna. Therefore, implementation of inter-element decoupling of the dual-polarization array antenna plays an important role in improving antenna performance.

The following describes the antenna provided in embodiments of this application with reference to the foregoing application scenario.

As shown in FIG. 2, an embodiment of an antenna provided in embodiments of this application includes a conductor sheet 3, a fastening structure 5, a parasitic patch 4, a substrate 2, a ground plate 1, a first metal structure 6, a second metal structure 7, a third metal structure 9, and a fourth metal structure 8.

To better describe the antenna, a three-dimensional coordinate system is established for the antenna. A vertical direction of the antenna is a Z-axis direction, and horizontal directions of the antenna are an X-axis direction and a Y-axis direction.

The antenna is a dual-polarization antenna, and the antenna includes three conductor sheets 3. The conductor sheet 3 may be understood as an array element of the antenna. The three array elements are arranged in the horizontal direction (specifically in the Y-axis direction) of the antenna to form an antenna array, and spacings between the three array elements are the same. The spacing may be 0.5 times a wavelength of the antenna. Each array element is a ±45° dual-polarization conductor sheet 3, and P1 to P6 are six input ports of the three dual-polarization antenna elements.

Further, in the vertical direction of the antenna, the conductor sheet 3 is located above the ground plate 1, the fastening structure 5 is disposed above the conductor sheet 3, the conductor sheet 3 is disposed on a surface of the substrate 2, the substrate 2 is disposed on a surface of the ground plate 1, the parasitic patch 4 is located above the conductor sheet 3, and the parasitic patch 4 is disposed inside the fastening structure 5. In other words, in a structure of the antenna, from bottom to top, there are sequentially the ground plate 1, the substrate 2, the conductor sheet 3, and the fastening structure 5. The ground plate 1, the substrate 2, the conductor sheet 3, and the fastening structure 5 may be attached to each other, or may be spaced apart. For example, the ground plate 1 and the substrate 2 are spaced apart by a preset distance in the vertical direction of the antenna, and the parasitic patch 4 is disposed inside the fastening structure 5.

The ground plate 1 may be understood as a reference ground of the antenna, the substrate 2 is specifically an element dielectric substrate 2, the conductor sheet 3 is specifically a dual-polarization antenna element patch, the parasitic patch 4 is configured to expand antenna bandwidth, the fastening structure 5 is specifically a decoupling structure medium, and the fastening structure 5 and the conductor sheet 3 may be attached to each other or spaced apart by the preset distance in the vertical direction of the antenna. In addition, the fastening structure 5 may be replaced with another structure or apparatus configured to fasten the first metal structure 6, the second metal structure 7, the third metal structure 9, and the fourth metal structure 8. For example, the fastening structure 5 is a dielectric layer.

It should be understood that the ground plate 1, the substrate 2, the conductor sheet 3, the fastening structure 5, and the parasitic patch 4 are basic structures of the antenna, and a person skilled in the art may adjust the basic structures based on an actual situation, for example, remove the ground plate 1 or the parasitic patch 4.

Further, in the vertical direction of the antenna, the first metal structure 6 and the second metal structure 7 are located above the conductor sheet 3, and in the horizontal direction of the antenna, the first metal structure 6 and the second metal structure 7 are perpendicular to each other. Based on an electromagnetic wave diffraction effect and coupling effect, the first metal structure 6 and the second metal structure 7 are loaded above the antenna element as a parasitic decoupling structure, so that an additional coupling path can be introduced, to offset original coupling energy. This implements antenna decoupling. In addition, based on structures of the first metal structure 6 and the second metal structure 7, in the vertical direction of the antenna, a distance between the first metal structure 6 and the ground plate 1 may be 0.01 to 0.2 times the wavelength of the antenna, for example, 0.156 times the wavelength of the antenna. A distance between the second metal structure 7 and the ground plate 1 is less than or equal to the distance between the first metal structure 6 and the ground plate 1. In the horizontal direction of the antenna, a length of the first metal structure 6 and the second metal structure 7 is 0.1 to 1 times the wavelength of the antenna. In the foregoing distance limitations, antenna decoupling can still be implemented. Therefore, it can be learned that in the vertical direction of the antenna, a height of the antenna may be low, to reduce a size of the antenna. This avoids a problem of increased costs, size, and weight.

The antenna wavelength may be understood as an operating wavelength of the antenna, namely, a wavelength corresponding to an operating frequency band of the antenna. Specifically, the first metal structure 6 is parallel to the X-axis direction, the second metal structure 7 is parallel to the Y-axis direction, and the first metal structure 6 and the second metal structure 7 are specifically conductive patches, may be distributed in a same plane or different planes, and are not connected to each other. In addition, in the vertical direction of the antenna, the first metal structure 6 is disposed on a surface of the fastening structure 5. Because the parasitic patch 4 is disposed inside the fastening structure 5, the parasitic patch 4 is located below the first metal structure 6.

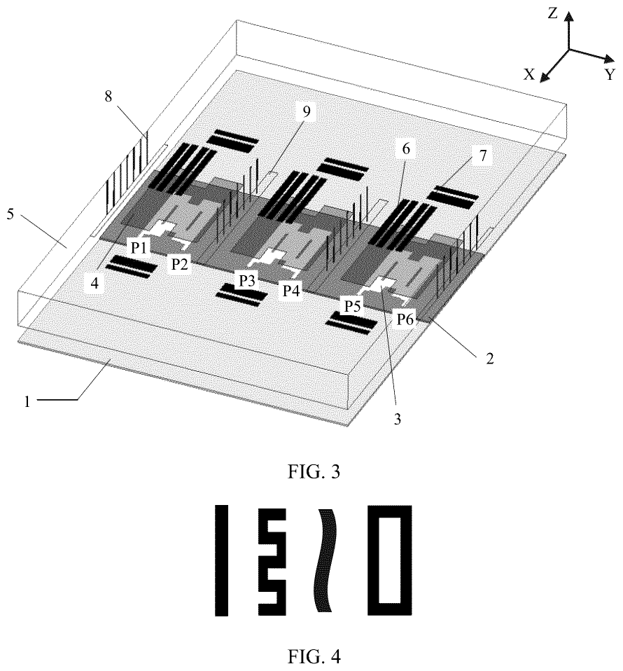

Optionally, the height of the second metal structure 7 is between the height of the first metal structure 6 and a height of the parasitic patch 4. In other words, the second metal structure 7 may be disposed on the surface of the fastening structure 5 like the first metal structure 6 as shown in FIG. 2, or may be disposed between the first metal structure 6 and the parasitic patch 4, that is, inside the fastening structure 5 as shown in FIG. 3. In the horizontal direction of the antenna, the first metal structure 6 and the second metal structure 7 may be located on two sides of the conductor sheet 3. For example, both the first metal structure 6 and the second metal structure 7 are located right above the conductor sheet 3 in FIG. 2, or the first metal structure 6 is located right above the conductor sheet 3 and the second metal structure 7 is located on two sides of the conductor sheet 3 in FIG. 3.

Optionally, the first metal structure 6 and the second metal structure 7 may be in a metal strip shape (rectangle shape) shown in FIG. 2, or may be one or more of a zigzag shape, a curved shape, or a ring shape shown in FIG. 4.

Further, in the vertical direction of the antenna, the third metal structure 9 is disposed on the surface and/or a bottom surface of the fastening structure 5. In the horizontal direction of the antenna, the third metal structure 9 is located on two sides of the first metal structure 6 and the second metal structure 7, and the third metal structure 9 is parallel to the first metal structure 6. The fourth metal structure 8 is parallel to the vertical direction of the antenna, at least one end of the fourth metal structure 8 is connected to the third metal structure 9, and the fourth metal structure 8 is configured to connect the surface of the fastening structure 5 to the bottom surface of the fastening structure 5.

Specifically, the third metal structure 9 may be of a metal strip structure. The third metal structure 9 may be disposed on the surface and the bottom surface of the fastening structure 5 as shown in FIG. 2, or may be disposed only on the bottom surface of the fastening structure 5 as shown in FIG. 3. Alternatively, the third metal structure 9 may be disposed only on the surface of the fastening structure 5. In addition, the third metal structure 9 is located on the two sides of the first metal structure 6 and the second metal structure 7, that is, located on the two sides of the conductor sheet 3. In the horizontal direction of the antenna, the third metal structure 9 is parallel to the first metal structure 6. In other words, the third metal structure 9 and the second metal structure 7 are perpendicular to each other.

The fourth metal structure 8 may also be of a metal strip structure. The fourth metal structure 8 is parallel to the vertical direction of the antenna, namely, the Z-axis. In other words, in the vertical direction of the antenna, the fourth metal structure 8 is perpendicular to the third metal structure 9, the fourth metal structure 8 passes through the fastening structure 5 and is configured to connect the surface of the fastening structure 5 to the bottom surface of the fastening structure 5, and a length of the fourth metal structure 8 is equal to a height of the fastening structure 5. As shown in FIG. 2, when the third metal structure 9 is disposed on the surface and the bottom surface of the fastening structure 5, two ends of the fourth metal structure 8 are respectively connected to the third metal structure 9 located on the surface of the fastening structure 5 and the third metal structure 9 located on the bottom surface of the fastening structure 5, to form a ladder-shaped structure. As shown in FIG. 3, when the third metal structure 9 is disposed only on the bottom surface of the fastening structure 5, one end of the fourth metal structure 8 is connected to the third metal structure 9 located on the bottom surface of the fastening structure 5, and the other end of the fourth metal structure 8 is connected to the surface of the fastening structure 5, to form a comb-shaped structure.

The third metal structure 9 is loaded, so that self-isolation of the antenna can be improved, to improve isolation between adjacent elements. The fourth metal structure 8 is loaded, so that a cross-polarization ratio of the antenna can be improved, to improve a polarization effect of the antenna.

Optionally, a structure of the fourth metal structure 8 is one or more of a metal sheet, a metal column, and a metal through via.

It should be understood that, the first metal structure 6, the second metal structure 7, the third metal structure 9, and the fourth metal structure 8 may be collectively referred to as the decoupling structure. The antenna may be understood as including the conductor sheet 3, the fastening structure 5, the parasitic patch 4, the substrate 2, the ground plate 1, and the decoupling structure. In addition, the parasitic patch 4 and the fastening structure 5 may alternatively be coupled to the decoupling structure. A skilled person may additionally load the decoupling structure in a conventional antenna, or load the decoupling structure when the antenna is manufactured.

It should be understood that the antenna provided in this embodiment of this application may be used in any operating frequency band, and the spacing between the elements in the antenna array may be smaller. This is not limited in this embodiment of this application.

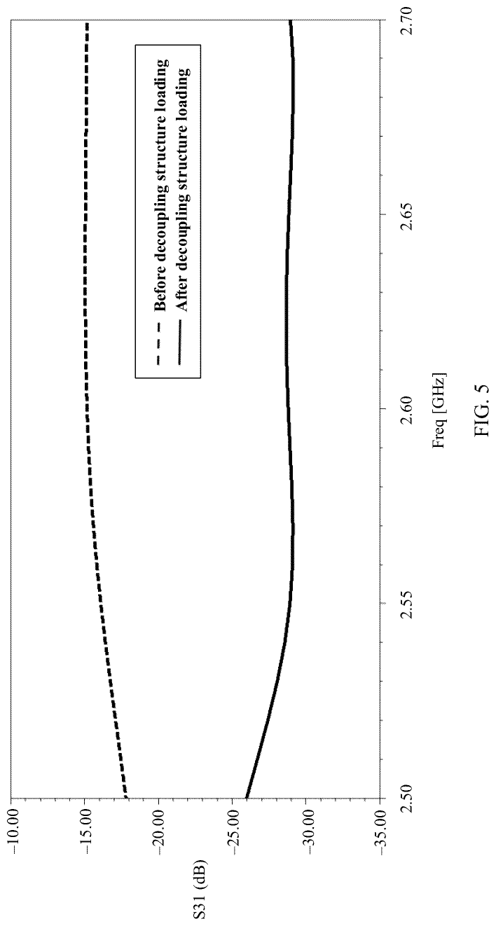

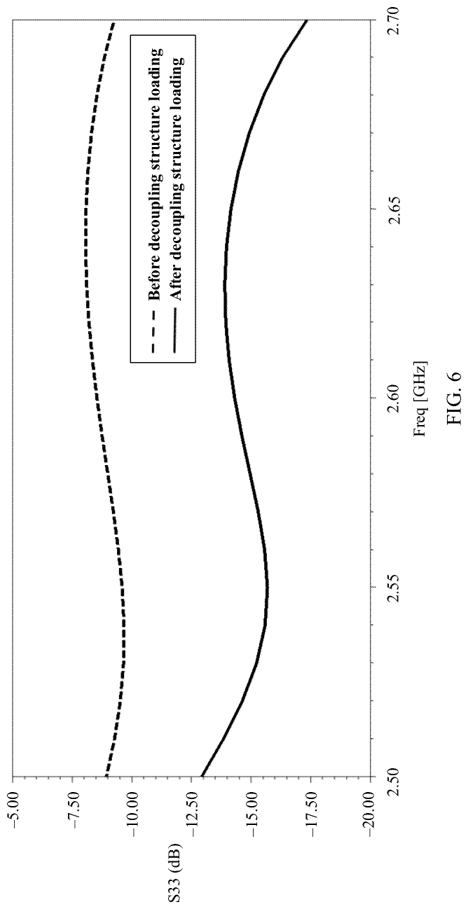

An antenna array that is not loaded with the decoupling structure provided in this embodiment of this application is compared with the antenna array that is loaded with the decoupling structure provided in this embodiment of this application. As shown in FIG. 5, in different operating frequency bands (Freq) of the antenna, after the decoupling structure provided in this embodiment of this application is loaded, isolation between the elements (for example, S31, indicating isolation from the port P1 to the port P3) is significantly improved, and mutual coupling between the adjacent elements is greatly reduced. As shown in FIG. 6, in different operating frequency bands (Freq) of the antenna, after the decoupling structure provided in this embodiment of this application is loaded, element matching (for example, S33, indicating a reflection coefficient of the P3 port) is significantly improved, and port reflection decreases. As shown in FIG. 5, after the decoupling structure provided in this embodiment of this application is loaded at different tilt angles (Theta) of the antenna, antenna directivity coefficients (Directivity, D) are compared. A horizontal beam width of a central element is widened, so that a larger horizontal beam scanning range can be obtained after the antenna forms a massive array. It can be learned that the decoupling structure provided in this embodiment of this application has a good decoupling effect.

It can be learned from a summary of the foregoing embodiments that the antenna provided in this embodiment of this application can bring beneficial effects that include but are not limited to the following three beneficial effects:

(1) The additional coupling path is introduced by using the decoupling structure above the antenna element, to offset the original coupling energy of the antenna. This implements decoupling of the dual-polarization antenna.

(2) The height of the antenna does not increase significantly after the decoupling structure is loaded, and a structure is simple. This avoids a problem of increased costs, size, and weight caused after the decoupling structure is added.

(3) The decoupling structure is used to greatly improve co-polarization isolation between the adjacent elements, improve a matching characteristic of the antenna element, increase a horizontal direction beam width of the element, and improve a scanning capability of the antenna.

The foregoing describes the antenna provided in embodiments of this application. The following describes, with reference to the accompanying drawings, a decoupling structure and a communication device that are provided in embodiments of this application.

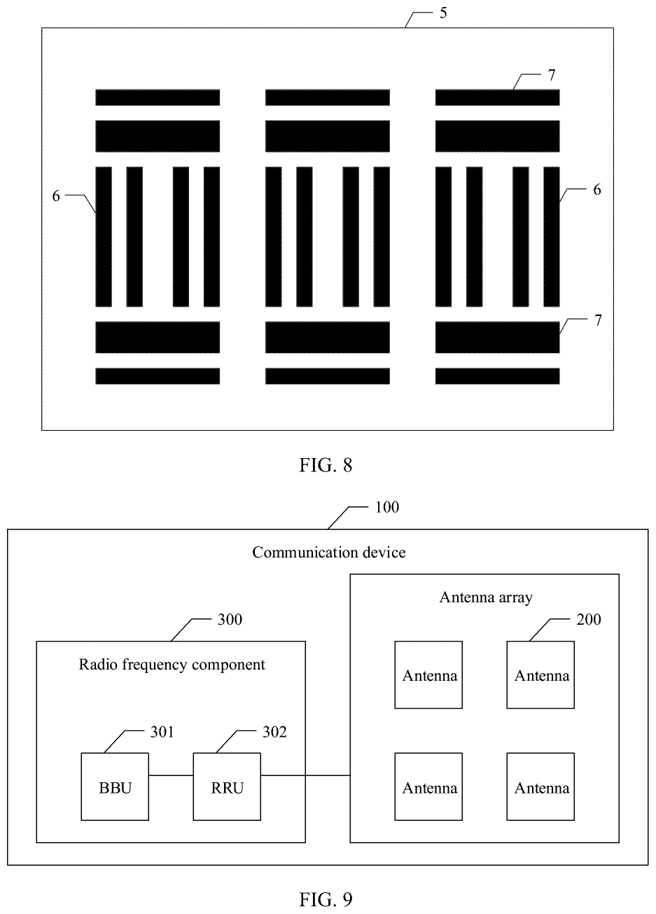

As shown in FIG. 8, an embodiment of the decoupling structure provided in embodiments of this application includes the first metal structure 6 and the second metal structure 7. For a direction of the decoupling structure, refer to the foregoing antenna direction. In a horizontal direction of the decoupling structure, the first metal structure 6 and the second metal structure 7 are perpendicular to each other.

Optionally, the decoupling structure further includes a structure, for example, the fastening structure 5, configured to fasten the first metal structure 6 and the second metal structure 7. In a vertical direction of the decoupling structure, the first metal structure 6 is disposed on the surface of the fastening structure 5.

The decoupling structure is used in the antenna. In other words, the decoupling structure is configured to be installed in the antenna. For a specific implementation of the decoupling structure provided in this embodiment of this application, refer to corresponding descriptions in the foregoing antenna embodiment. For example, refer to FIG. 2. The decoupling structure further includes the third metal structure 9, the fourth metal structure 8, and the parasitic patch 4. In the vertical direction of the decoupling structure, the third metal structure 9 is disposed on the surface and/or the bottom surface of the fastening structure 5. In the horizontal direction of the decoupling structure, the third metal structure 9 is located on the two sides of the first metal structure 6 and the second metal structure 7, and the third metal structure 9 is parallel to the first metal structure 6. The fourth metal structure 8 is parallel to the vertical direction of the decoupling structure. At least one end of the fourth metal structure 8 is connected to the third metal structure 9. The fourth metal structure 8 is configured to connect the surface of the fastening structure 5 to the bottom surface of the fastening structure 5. In the vertical direction of the decoupling structure, the parasitic patch 4 is located below the first metal structure 6, and the parasitic patch 4 is disposed inside the fastening structure 5. In the vertical direction of the decoupling structure, the height of the second metal structure 7 is between the height of the first metal structure 6 and the height of the parasitic patch 4.

After the decoupling structure is installed on the antenna, in the vertical direction of the antenna, the distance between the first metal structure 6 and the ground plate 1 may be 0.01 to 0.2 times the wavelength of the antenna, for example, 0.156 times the wavelength of the antenna. The distance between the second metal structure 7 and the ground plate 1 is less than or equal to the distance between the first metal structure 6 and the ground plate 1. In the horizontal direction of the antenna, the length of the first metal structure 6 and the second metal structure 7 is 0.1 to 1 times the wavelength of the antenna. Therefore, it can be learned that in the vertical direction of the antenna, the height of the antenna may be low, to reduce the size of the antenna. This avoids a problem of increased costs, size, and weight.

It should be understood that the decoupling structure may alternatively not include the parasitic patch 4 and the fastening structure 5, and the fastening structure 5 may be replaced with another structure or apparatus configured to fasten the first metal structure 6, the second metal structure 7, the third metal structure 9, and the fourth metal structure 8. For example, the fastening structure 5 is the dielectric layer.

Optionally, the first metal structure 6 and the second metal structure 7 are in one or more of a rectangle shape, a zigzag shape, a curved shape, or a ring shape. The structure of the fourth metal structure 8 is one or more of a metal sheet, a metal column, and a metal through via.

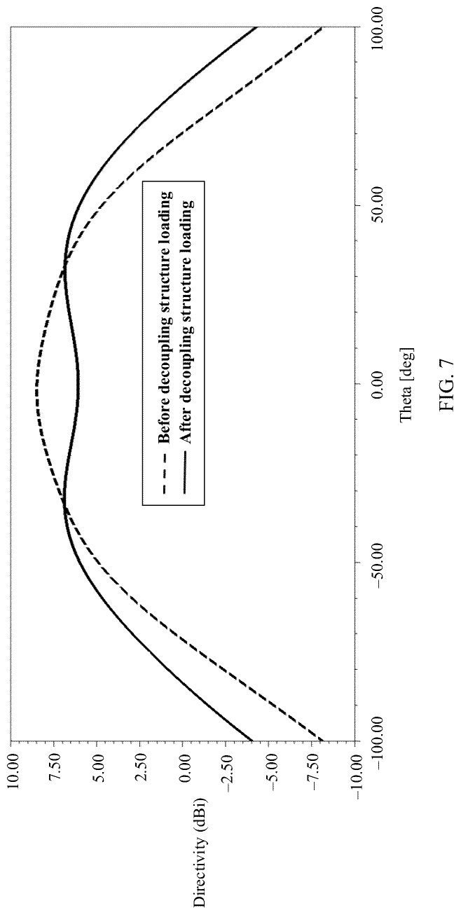

As shown in FIG. 9, an embodiment of a communication device 100 provided in an embodiment of this application includes the antenna 200 described in embodiments in FIG. 2 to FIG. 7, and a radio frequency component 300 coupled to the antenna 200.

The communication device 100 is specifically a 5G MM base station, for example, the base station shown in FIG. 1. The antenna 200 in the base station is the antenna described in embodiments in FIG. 2 to FIG. 7. There are a plurality of antennas 200 that form the antenna array. The radio frequency component includes a baseband processing unit (BBU) 301 and a remote radio unit (RRU) 302. The RRU 302 and the antenna 200 may be coupled as an active antenna unit (AAU). The BBU is responsible for processing signaling and data of a core network and a user by using a main control board and a baseband board in the BBU, the RRU is configured to convert a baseband signal transmitted by the baseband board through an optical fiber into a high-frequency signal in a frequency band owned by an operator, and transmit the high-frequency signal to the antenna 200 through a feeder. The antenna 200 is configured to send a wireless signal.

The antenna 200 in the base station is loaded with the decoupling structure provided in this embodiment of this application, and has the same beneficial effect as the antenna described in embodiments in FIG. 2 to FIG. 7.

In the several embodiments provided in this application, it should be understood that the disclosed structure may be implemented in another manner. For example, the described embodiments are merely examples. For example, the structure division may be other division in actual implementation. For example, a plurality of units or components may be combined or integrated into another structure, or some features may be ignored. Some or all of the structures may be selected based on an actual need to achieve the objectives of the solutions of embodiments.

The foregoing embodiments are merely intended to describe the technical solutions of this application, but are not intended to limit this application. Although this application is described in detail with reference to the foregoing embodiments, a person of ordinary skill in the art should understand that the technical solutions described in the foregoing embodiments may still be modified or some technical features thereof may be equivalently replaced. These modifications or replacements do not enable essence of a corresponding technical solution to depart from the scope of the technical solutions of embodiments of this application.

1. An antenna, comprising a ground plate, a conductor sheet, a first metal structure, and a second metal structure, wherein in a vertical direction of the antenna, the first metal structure and the second metal structure are located above the conductor sheet, the conductor sheet is located above the ground plate, a distance between the first metal structure and the ground plate ranges from 0.01 to 0.2 times a wavelength of the antenna, and a distance between the second metal structure and the ground plate is less than or equal to the distance between the first metal structure and the ground plate; and
in a horizontal direction of the antenna, the first metal structure and the second metal structure are perpendicular to each other.

2. The antenna according to claim 1, wherein the antenna further comprises a fastening structure; and
in the vertical direction of the antenna, the fastening structure is disposed above the conductor sheet, and the first metal structure is disposed on a first surface of the fastening structure.

3. The antenna according to claim 2, wherein the antenna further comprises a third metal structure;
in the vertical direction of the antenna, the third metal structure is disposed on at least one of the first surface or a bottom surface of the fastening structure; and
in the horizontal direction of the antenna, the third metal structure is located on two sides of the first metal structure and the second metal structure, and the third metal structure is parallel to the first metal structure.

4. The antenna according to claim 3, wherein the antenna further comprises a fourth metal structure;
the fourth metal structure is parallel to the vertical direction of the antenna;
at least one end of the fourth metal structure is connected to the third metal structure; and
the fourth metal structure is configured to connect the first surface of the fastening structure to the bottom surface of the fastening structure.

5. The antenna according to claim 2, wherein the antenna further comprises a parasitic patch;
in the vertical direction of the antenna, the parasitic patch is located above the conductor sheet and below the first metal structure; and
the parasitic patch is disposed inside the fastening structure.

6. The antenna according to claim 5, wherein in the vertical direction of the antenna, a height of the second metal structure is between a height of the first metal structure and a height of the parasitic patch.

7. The antenna according to claim 1, wherein in the horizontal direction of the antenna, the first metal structure and the second metal structure are located on two sides of the conductor sheet.

8. The antenna according to claim 1, wherein the antenna further comprises a substrate; and
in the vertical direction of the antenna, the conductor sheet is disposed on a surface of the substrate, and the substrate is disposed on a surface of the ground plate.

9. The antenna according to claim 1, wherein in the horizontal direction of the antenna, lengths of the first metal structure and the second metal structure range from 0.1 to 1 times the wavelength of the antenna.

10. The antenna according to claim 1, wherein the first metal structure and the second metal structure are in one or more of a rectangle shape, a zigzag shape, a curved shape, or a ring shape.

11. The antenna according to claim 4, wherein a structure of the fourth metal structure is one or more of a metal sheet, a metal column, or a metal through via.

12. The antenna according to claim 1, wherein the antenna is a dual-polarization antenna.

13. A decoupling structure, comprising a first metal structure, a second metal structure, a third metal structure, a fourth metal structure, and a fastening structure, wherein
in a vertical direction of the decoupling structure, the first metal structure is disposed on a first surface of the fastening structure, and the third metal structure is disposed on at least one of the first surface and/or or a bottom surface of the fastening structure;
in a horizontal direction of the decoupling structure, the first metal structure and the second metal structure are perpendicular to each other, the third metal structure is located on two sides of the first metal structure and the second metal structure, and the third metal structure is parallel to the first metal structure;
the fourth metal structure is parallel to the vertical direction of the decoupling structure;
at least one end of the fourth metal structure is connected to the third metal structure; and
the fourth metal structure is configured to connect the first surface of the fastening structure to the bottom surface of the fastening structure.

14. The decoupling structure according to claim 13, wherein the decoupling structure further comprises a parasitic patch;
in the vertical direction of the decoupling structure, the parasitic patch is located below the first metal structure; and
the parasitic patch is disposed inside the fastening structure.

15. The decoupling structure according to claim 14, wherein in the vertical direction of the decoupling structure, a height of the second metal structure is between a height of the first metal structure and a height of the parasitic patch.

16. The decoupling structure according to claim 13, wherein the first metal structure and the second metal structure are in one or more of a rectangle shape, a zigzag shape, a curved shape, or a ring shape.

17. The decoupling structure according to claim 13, wherein a structure of the fourth metal structure is one or more of a metal sheet, a metal column, or a metal through via.

18. A communication device, comprising an antenna and a radio frequency component coupled to the antenna, wherein the antenna comprises a ground plate, a conductor sheet, a first metal structure, and a second metal structure, wherein
in a vertical direction of the antenna, the first metal structure and the second metal structure are located above the conductor sheet, the conductor sheet is located above the ground plate, a distance between the first metal structure and the ground plate ranges from 0.01 to 0.2 times a wavelength of the antenna, and a distance between the second metal structure and the ground plate is less than or equal to the distance between the first metal structure and the ground plate; and
in a horizontal direction of the antenna, the first metal structure and the second metal structure are perpendicular to each other.

19. The communication device according to claim 18, wherein the antenna further comprises a fastening structure; and
in the vertical direction of the antenna, the fastening structure is disposed above the conductor sheet, and the first metal structure is disposed on a first surface of the fastening structure.

20. The communication device according to claim 19, wherein the antenna further comprises a third metal structure;
in the vertical direction of the antenna, the third metal structure is disposed on at least one of the first surface or a bottom surface of the fastening structure; and
in the horizontal direction of the antenna, the third metal structure is located on two sides of the first metal structure and the second metal structure, and the third metal structure is parallel to the first metal structure.
